(19) United States
(12) Patent Application Publication
(10) Pub. No.: US 2021/0363463 A1
(43) Pub. Date: Nov. 25, 2021

(54) A MEMBRANE-BASED METHOD FOR DECOLORIZING VEGETABLE WAX

(71) Applicant: EVONIK SPECIALTY CHEMICALS (SHANGHAI) CO., LTD., Shanghai (CN)

(72) Inventors: Jianchao XIE, Shanghai (CN); Hongxi ZHANG, Shanghai (CN)

(73) Assignee: EVONIK SPECIALTY CHEMICALS (SHANGHAI) CO., LTD., Shanghai (CN)

(21) Appl. No.: 16/764,319

(22) PCT Filed: Nov. 12, 2018
(86) PCT No.: PCT/CN2018/114939

§ 371 Date: May 14, 2020

(30) Foreign Application Priority Data
Nov. 16, 2017 (CN) 201711135977.4

(51) Int. Cl. C11B 11/00; B01D 61/02; B01D 71/42; B01D 71/70; B01D 69/02; B01D 69/12; B01D 71/64

(52) U.S. Cl. CPC C11B 11/00; B01D 61/027; B01D 61/022; B01D 71/42; B01D 71/70; B01D 2325/20; B01D 69/12; B01D 71/64; B01D 2325/34; B01D 2317/025; B01D 2311/25; B01D 69/02

(57) ABSTRACT

In the method for decolorizing a vegetable wax, a vegetable wax raw material dissolved in an organic solvent is contacted under pressure with a nanofiltration membrane having a higher rejection for a pigment, contained in the vegetable wax raw material, than for the wax components, providing a permeate containing decolorized wax and enriching the pigment in the retentate.

### FIELD OF THE INVENTION

The present invention pertains to the refining of vegetable waxes, and particularly relates to a membrane-based method for decolorizing a vegetable wax.

### BACKGROUND OF THE INVENTION

Vegetable waxes have a wide range of industrial uses, as described in Ullmann's Encyclopedia of Industrial Chemistry, entry “waxes”, DOI 10.1002/14356007.a28_103.pub2.

Crude vegetable waxes often contain colored substances and have a dark color, for example, crude rice bran wax is dark brown, leading to limited use, such that a decolorization treatment is needed.

Some methods for decolorizing rice bran wax have been disclosed in the prior art.

JP 51-30204 relates to the use of hydrogen peroxide for a reaction with a pigment in rice bran wax, which method involves multiple steps and leaves residual hydrogen peroxide in the wax.

CN 1071446 A relates to decolorization by thermal insulation column chromatography using an adsorbent. However, the method consumes a large amount of solvent and produces a large amount of adsorbent solid waste.

CN 103981032 A relates to adding a decolorizing adsorbent, with cyclohexane as a solvent, for a decolorization treatment. However, this method still produces a large amount of adsorbent solid waste.

In view of the deficiencies of the prior art, there is a need to develop a new method for decolorizing vegetable waxes including rice bran wax.

The inventors have explored the possibility of decolorizing a vegetable wax including rice bran wax by using an organic solvent nanofiltration membrane, thereby completing the present invention.

### SUMMARY OF THE INVENTION

The present invention provides a membrane-based method for decolorizing a vegetable wax, the method comprising the following steps:
i) providing a vegetable wax raw material liquid comprising an organic solvent and a vegetable wax dissolved therein;
ii) providing a selectively permeable first nanofiltration membrane having a first surface and a second surface; and
iii) bringing said raw material liquid into contact with the first surface of said first nanofiltration membrane to transfer a portion of said raw material liquid across the first nanofiltration membrane, from the first surface to the second surface, thereby forming a first permeate and a first retentate,

wherein the pressure at the first surface of the first nanofiltration membrane is higher than the pressure at the second surface of the first nanofiltration membrane, said vegetable wax comprises a pigment and a wax component, and the rejection of said first nanofiltration membrane for said pigment is higher than that for said wax component.

The method of the present invention is capable of enriching a pigment in the first retentate, while the wax component can pass through the nanofiltration membrane along with the first permeate, thereby reducing the pigment content of the vegetable wax in the first permeate, so that the method can be widely used for the decolorization of vegetable waxes.

Compared to existing methods in the prior art, the present invention is an alternative new method which has the following advantages: no need to add any additional chemical and no need to regenerate the membrane material which is used.

The method of the present invention may further comprise the following membrane concentration step of
bringing said first permeate into further contact with a second nanofiltration membrane to transfer a portion of said first permeate across the second nanofiltration membrane, from a first surface of the second nanofiltration membrane to a second surface of the second nanofiltration membrane, thereby forming a second permeate and a second retentate, wherein the pressure at the first surface of the second nanofiltration membrane is greater than the pressure at the second surface of the second nanofiltration membrane, and the rejection of said second nanofiltration membrane for said wax component is at least 80%.

This additional membrane concentration step can enrich the decolorized vegetable wax in the second retentate. Compared with traditional distillation and concentration methods, this method has the advantage of a low energy consumption.

### BRIEF DESCRIPTION OF DRAWINGS

FIG. 1 shows a schematic diagram of decolorizing by the nanofiltration method of the present invention comprising recycling of the first retentate (5) by combining it with the vegetable wax raw material liquid (7).

FIG. 2 shows a schematic diagram of a membrane concentration step used in a preferred embodiment of the present invention comprising recycling of the second retentate (12) by combining it with the first permeate (6).

### DETAILED DESCRIPTION OF THE INVENTION

Membrane technology is a relatively new technology for separating a mixture of substances. The basic principle thereof is to contact the mixture of substances to be separated with a membrane, which membrane has different permeabilities for individual components present in the mixture. This allows the various components present in the mixture of substances to be separated by passing through (i.e. permeating) the membrane at different rates, and thus, these components are concentrated to different concentrations on both sides of the membrane. Therefore, the separation criterion is the permeability of the membrane for a substance to be separated. The driving force is mainly a pressure gradient between the two sides of the membrane, i.e., so-called transmembrane pressure Δp. In addition, other driving forces may also be used.

The membrane technology not only acts by a mechanical screening function for selecting components according to different particle sizes, but also involves dissolution and diffusion effects. Since membranes operates in a significantly more complex manner than a simple mechanical filter, it is also possible to separate a liquid or a gas from each other.

In a specific technical configuration, the mixture to be separated is delivered as a feed to the membrane. There, it is separated into a retentate on the feed side of the membrane and a permeate on the other side of the membrane and the permeate and the retentate are continuously discharged from the membrane. Due to the separation effect, components for which the membrane is highly permeable become enriched in the permeate, while substances for which the membrane is less permeable are collected in the retentate. Since many membrane processes use membranes that are in principle permeable for all components in the mixture of substances, having only different rates of passage for these components, all components of the mixture of substances are present in both the retentate and the permeate, but the concentrations (mass fraction) thereof are different.

In membrane technology, permeability of a membrane for a particular component in a mixture of substances is characterized by the rejection R of the membrane, which is defined as:

R=1−w_{P}/w_{R}

where w_{P} is the mass fraction of the component in the permeate and w_{P} is the mass fraction of the component in the membrane retentate. The rejection R may therefore have a value of from 0 to 1, and is therefore preferably given in %. In the case of a simple two-component system, for example, a rejection of 0 or 0% indicates that the component being studied permeates exactly as the solvent, which means that the mass fraction of the component in the retentate is the same as that in the permeate. On the other hand, a rejection of 1 or 100% indicates that the component is completely retained by the membrane.

In addition to the rejection R, the so-called membrane permeability P is also decisive for characterizing the permeability, P being defined as

P=m′(Δ×Δp)

where m′ is the mass flow of the permeate, A is the area of the membrane, and Δp is the transmembrane pressure. The permeability is usually expressed in units of kg/(h×m²×bar).

The principles of membrane technology are summarized in Melin/Rautenbach: Membranverfahren. Grundlagen der Modul-und Anlagenauslegung. [Membrane Processes. Fundamentals of Module and System Design] Springer, Berlin Heidelberg 2004, for reference.

The term “nanofiltration” as used in the present invention refers to a synthetic membrane that provides a nominal molecular weight cut-off of from 150 g/mol to 1,500 g/mol, where the nominal molecular weight cut-off means that at this molecular weigh, said membrane provides a rejection of 90% for a range of polystyrene oligomers (e.g. polystyrene polymer standard substances with a nominal Mp of 1,000, reference number PL2012-3010, and a nominal Mp of 580, reference number PL2012-2010, vailable from Agilent Technologies) according to a method described in Toh et al., J. Membrane Sci., 291 (2007) 120-125. Nanofiltration membranes are different from ultrafiltration membranes having a molecular weight cut-off range of 2,000 to 2,000,000 g/mol and microfiltration membranes having pore diameters of 0.2 microns and more.

The term may be used for either aqueous nanofiltration or organophilic nanofiltration, depending on whether the membrane is primarily used for separating an aqueous mixture of substances or a mixture of organic substances. Since membrane materials have proven to vary greatly in terms of resistance and particularly in their swelling behaviour in aqueous or organic media, such differences are of great significance to those skilled in the membrane field.

The first nanofiltration membrane and/or second nanofiltration membrane used according to the present invention may comprise a polymer membrane, a ceramic membrane or a hybrid polymer/inorganic membrane.

The first nanofiltration membrane and/or second nanofiltration membrane used in the method of the present invention may be formed from any polymer or ceramic material that provides a separating layer capable of separating a vegetable wax from pigment therein. For example, said first nanofiltration membrane and/or second nanofiltration membrane may be formed from or comprise materials selected from polymer materials suitable for manufacturing nanofiltration membranes, preferably including polyethylene, polypropylene, polytetrafluoroethylene (PTFE), polyvinylidene fluoride (PVDF), polysulfone, polyethersulfone, polyacrylonitrile, polyamide, polyimide, polyamideimide, polyetherimide, cellulose acetate, polyaniline, polypyrrole, polyetheretherketone (PEEK), polybenzimidazole and mixtures thereof. Said first nanofiltration membrane and/or second nanofiltration membrane may be prepared by means of any technique known in the art, including sintering, drawing, track etching, template leaching, interfacial polymerization, or phase inversion. In a preferred embodiment, said first nanofiltration membrane and/or second nanofiltration membrane may be cross-linked or treated so as to improve the stability thereof in the organic solvent. For example, as a non-limiting example, a membrane described in GB 2437519, the contents of which are incorporated herein by reference, may be used for the present invention.

In a preferred embodiment, the first nanofiltration membrane and/or second nanofiltration membrane is a crosslinked or non-crosslinked composite material comprising a carrier and a thin selectively permeable layer. The thin selectively permeable layer may, for example, be formed from or comprise a material selected from: modified polysiloxane-based elastomers, including a polydimethylsiloxane (PDMS)-based elastomer, an ethylene-propylene-diene (EPDM)-based elastomer, a polynorbornene-based elastomer, a polycyclooctene-based elastomer, a polyurethane-based elastomer, a butadiene and butadiene-acrylonitrile rubber-based elastomer, a natural rubber, a butyl rubber-based elastomer, a neoprene-based elastomer, an epichlorohydrin elastomer, a polyacrylate elastomer, polyethylene, polypropylene, polytetrafluoroethylene (PTFE), a polyvinylidene fluoride (PVDF)-based elastomer, a polyether block amide (PEBAX), a crosslinked polyether, polyamide, polyaniline, polypyrrole, and mixtures thereof, particularly preferably a thin selectively permeable layer comprising a polysiloxane-based elastomer.

The first nanofiltration membrane preferably comprises a silicone-coated organic solvent nanofiltration membrane, more preferably a polyacrylonitrile-based nanofiltration membrane.

The second nanofiltration membrane preferably comprises a polyimide-based nanofiltration membrane, more preferably an uncoated organic solvent nanofiltration membrane.

In another embodiment, the first nanofiltration membrane and/or second nanofiltration membrane are prepared from an inorganic material such as silicon carbide, silicon oxide, zirconium oxide, titanium oxide, and zeolite, by using any technique known to a person skilled in the art, e.g., by sintering, leaching or sol-gel processing.

In another embodiment, the first nanofiltration membrane and/or second nanofiltration membrane comprise a polymer membrane, and the polymer membrane has a dispersed organic or inorganic matrix present in the form of a powdered solid in an amount of at most 20% by weight of said polymer membrane. A carbon molecular sieve matrix may be prepared by means of the pyrolysis of any suitable material as described in U.S. Pat. No. 6,585,802. A zeolite described in U.S. Pat. No. 6,755,900 may also be used as an inorganic matrix. Metal oxides may be used, for example, titanium dioxide, zinc oxide and silicon dioxide, such as those available from Evonik Industries AG (Germany) under the trademarks AEROSIL and ADNANO. Mixed metal oxides, such as a mixture of cerium, zirconium and magnesium oxides, may also be used. In at least one embodiment, the matrix comprises particles having a diameter of less than 1.0 μm, preferably less than 0.1 μm, more preferably less than 0.01 μm.

In all embodiments of the present invention, the first nanofiltration membrane and/or second nanofiltration membrane preferably have a molecular weight cut-off of from about 150 g/mol to about 1,500 g/mol, more preferably from about 200 g/mol to about 800 g/mol, particularly preferably from about 200 g/mol to about 600 g/mol. The first nanofiltration membrane preferably has a higher molecular weight cut-off than the second nanofiltration membrane. The first nanofiltration membrane preferably has a molecular weight cut-off of from 300 g/mol to 1500 g/mol, more preferably from 300 g/mol to 900 g/mol, in order to provide sufficient retention of pigments and sufficient permeation of wax components. The second nanofiltration membrane preferably has a molecular weight cut-off of less than 300 g/mol in order to provide efficient retention of wax components and a high enrichment of wax components in the second retentate.

The vegetable wax is not particularly limited and is preferably selected from palm wax, candelilla wax, rice bran wax, sugarcane wax, laurel wax, castor bean wax, jojoba wax, urushi wax, ouricury wax, sunflower wax, and douglas fir bark wax.

The term “wax component” refers to an ester of a long-chain aliphatic alcohol with a fatty acid. Such esters are the typical components of vegetable waxes and are present as mixtures of esters of fatty acids having different chain lengths with fatty alcohols having different chain lengths.

The organic solvent is not particularly limited. Preference is given to the following categories: aromatic hydrocarbons, aliphatic hydrocarbons, ketones, esters, ethers, nitriles, alcohols, furans, lactones and mixtures thereof. More preference is given to the following solvents: toluene, xylene, benzene, styrene, methyl acetate, ethyl acetate, isopropyl acetate, butyl acetate, methyl ether ketone (MEK), methyl isobutyl ketone (MIBK), acetone, isopropanol, propanol, butanol, hexane, heptane, cyclohexane, dimethoxyethane, methyl tert-butyl ether (MTBE), diethyl ether, adiponitrile, dioxane, tetrahydrofuran, methyl-tetrahydrofuran, N-methylpyrrolidone, N-ethylpyrrolidone, acetonitrile and mixtures of the foregoing substances.

The second nanofiltration membrane has a rejection for the wax component of at least 80%, preferably at least 90% and more preferably at least 95%. The second nanofiltration membrane preferably has a higher rejection for the wax component than the first nanofiltration membrane.

The first retentate is preferably recycled to the first surface of the first nanofiltration membrane, which is helpful in increasing the yield of the vegetable wax. More preferably, it is combined with the vegetable wax raw material liquid, which is more convenient to operate.

The second retentate is preferably recycled to the first surface of the second nanofiltration membrane, which is helpful in increasing the yield of the vegetable wax. More preferably, it is combined with the first permeate, which is more convenient to operate.

Preferably, the vegetable wax raw material liquid is continuously replenished with a replenishing liquid that is the organic solvent or a solution of the vegetable wax in the organic solvent, which is helpful in increasing the yield of the vegetable wax. The concentration of the vegetable wax in the replenishing liquid preferably does not exceed the concentration of the vegetable wax in the first permeate in order to improve efficiency. Preferably, the second permeate is used as replenishing liquid or for preparing the replenishing liquid to improve efficiency of solvent use.

Preferred operating conditions for the first nanofiltration membrane are:
a) a temperature of 10 to 100° C., preferably 30 to 80° C.;
b) a transmembrane pressure difference of 10 to 60 bar, preferably 20 to 50 bar; and/or
c) a vegetable wax concentration of 10 to 500 g/l, preferably 100 to 300 g/l.

Preferred operating conditions for the second nanofiltration membrane are:
a) a temperature of 10 to 100° C., preferably 30 to 80° C.; and/or
b) a transmembrane pressure difference of 10 to 60 bar, preferably 20 to 50 bar.

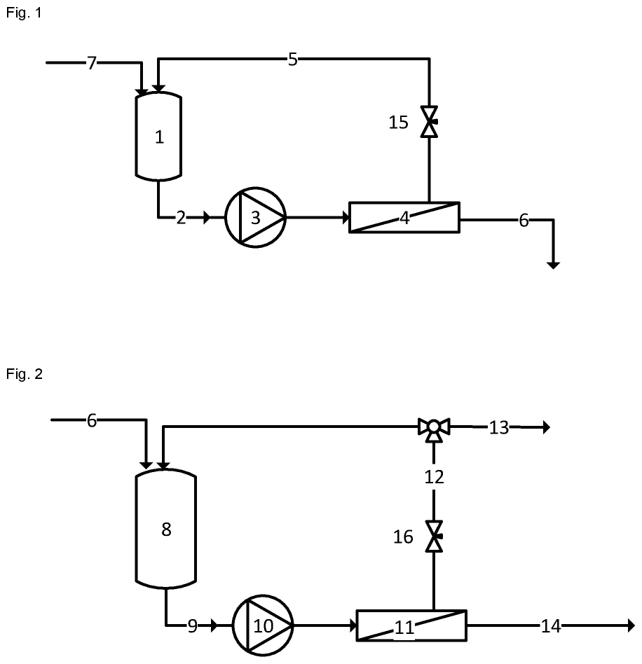

A separation system for carrying out the decolorizing method of the invention is shown in FIG. 1 and an additional membrane system for further concentrating the vegetable wax solution is shown in FIG. 2.

In the embodiment shown in FIG. 1 the decolorization step is carried out by supplying a batch of vegetable wax raw material liquid 7 to be decolorized to a feed tank 1. A pump 3 is used for delivering a stream 2 from the feed tank 1 to the first nanofiltration membrane 4, which has a higher rejection for the pigment contained in the vegetable wax than that for the wax component contained in the vegetable wax. A driving force for separation is generated by a back pressure valve 15, which maintains a transmembrane pressure differential that allows a portion of the stream 2 to permeate through the first nanofiltration membrane 4 to produce a first permeate 6 and a first retentate 5. The first retentate 5 is returned to the feed tank 1 while the feed tank 1 is continuously replenished with a vegetable wax raw material liquid 7, the flow rate of which and the vegetable wax concentration of which are the same as those of the first permeate 6. In this system, the pigment is continuously enriched in the first retentate 5 such that the content of the pigment in the first permeate 6 is reduced.

In the embodiment shown in FIG. 2 the membrane concentration step is carried out by collecting a certain quantity of the first permeate 6 and supplying same into a feed tank 8. A pump 10 is used for delivering a stream 9 from the feed tank 8 to the second nanofiltration membrane 11, which has a higher rejection for the wax component than for the organic solvent. A driving force for separation is generated by a back pressure valve 16, which maintains a transmembrane pressure differential that allows a portion of the stream 9 to permeate through the second nanofiltration membrane 11 to produce a second permeate 14 and a second retentate 12, and the second retentate 12 is returned to the feed tank 8. In this system, the vegetable wax component is continuously enriched in the second retentate 12. When it is enriched to a certain concentration, it can be taken out as a stream 13, and after the solvent is evaporated, a decolorized vegetable wax product is obtained; in addition, the second permeate 14, the vegetable wax component concentration of which is reduced, can be recycled, for example, to prepare the vegetable wax raw material liquid in the feed tank 1, or to prepare a vegetable wax raw material liquid to be replenished into the feed tank 1.

### EXAMPLES

The examples were carried out with a setup as shown in FIGS. 1 and 2. A spiral wound membrane module containing 0.1 m² of a nanofiltration membrane composed of an organic silicone coating on a polyacrylonitrile carrier, available under the trade name PuraMem® Flux from Evonik Specialty Chemicals (Shanghai) Co., Ltd., was used as the first nanofiltration membrane. A spiral wound module containing 0.1 m² of a polyimide nanofiltration membrane having a molecular weight cut-off of 280 g/mol, available under the trade name PuraMem® 280 from Evonik Specialty Chemicals (Shanghai) Co., Ltd., was used as the second nanofiltration membrane.

The color of the vegetable wax (before decolorizing and after decolorizing) was determined by color comparison using a Pantone card, to obtain a corresponding Pantone color number.

The wax components rejection was calculated from the dissolved solids contents of the permeate and the retentate, which were determined by evaporating the solvent and weighing the wax residue.

### Example 1

### Decolorization and Concentration of Rice Bran Wax

5 l of a solution of 200 g/l of crude rice bran wax (dark brown with a Pantone color number of 476U, available from Huzhou Shengtao Biotech LLC.) in ethyl acetate was prepared at 60° C. and provided in feed tank 1. Pump 3 was adjusted to provide a flow rate of 150 l/h, the system was kept at a temperature of 60° C. and the pressure was slowly raised to 30 bar. After the system stabilized, a first permeate 6 was collected at a flow rate of about 101/h, and feed tank 1 was continuously replenished with a 60° C. solution of 44 g/l rice bran wax in ethyl acetate at a flow rate of 10 l/h.

20 l of the first permeate 6 were collected and added to the liquid feed tank 8. Pump 10 was adjusted to provide a flow rate of 150 l/h, the system was kept at a temperature of 60° C., and the pressure was slowly raised to 30 bar. After the system had stabilized, a second permeate 14 was collected. When 15 l of the second permeate 14 had been collected, the pressure was released, 5 l of a second retentate 13 were discharged and evaporated to dryness to obtain a decolorized rice bran wax (light yellow, with a Pantone color number of 600U).

The first nanofiltration membrane provided a wax components rejection of 78% at a flux of 100 l/(m²h). The second nanofiltration membrane provided a wax components rejection of 95% at a flux of 75 l/(m²h).

### Example 2

### Decolorization and Concentration of Sugarcane Wax

5 l of a solution of 200 g/l of crude sugarcane wax (brown with a Pantone color number of 469U, available from Shanghai Tonix Chemical Co., Ltd.) in ethyl acetate was prepared at 60° C. and provided in feed tank 1. Pump 3 was adjusted to provide a flow rate of 150 l/h, the system was kept at a temperature of 60° C. and the pressure was slowly raised to 30 bar. After the system stabilized, a first permeate 6 was collected at a flow rate of about 7 l/h, and feed tank 1 was continuously replenished with a 60° C. solution of 40 g/l sugarcane wax in ethyl acetate at a flow rate of 7 l/h.

20 l of the first permeate 6 were collected and added to the liquid feed tank 8. Pump 10 was adjusted to provide a flow rate of 150 l/h, the system was kept at a temperature of 60° C., and the pressure was slowly raised to 30 bar. After the system had stabilized, a second permeate 14 was collected. When 15 l of the second permeate 14 had been collected, the pressure was released, 5 l of a second retentate 13 were discharged and evaporated to dryness to obtain a decolorized sugarcane wax (light yellow, with a Pantone color number of 600U).

The first nanofiltration membrane provided a wax components rejection of 80% at a flux of 70 l/(m²h). The second nanofiltration membrane provided a wax components rejection of more than 95% at a flux of 50 l/(m²h).

### Example 3

### Decolorization and Concentration of Palm Wax

5 l of a solution of 200 g/l of crude palm wax (brownish yellow with a Pantone color number of 145U, available from ShanghaiYiBa Raw Materials Co., Ltd.) in ethyl acetate was prepared at 60° C. and provided in feed tank 1. Pump 3 was adjusted to provide a flow rate of 150 l/h, the system was kept at a temperature of 60° C. and the pressure was slowly raised to 30 bar. After the system stabilized, a first permeate 6 was collected at a flow rate of about 5 l/h, and feed tank 1 was continuously replenished with a 60° C. solution of 60 g/l palm wax in ethyl acetate at a flow rate of 5 l/h.

20 l of the first permeate 6 were collected and added to the liquid feed tank 8. Pump 10 was adjusted to provide a flow rate of 150 l/h, the system was kept at a temperature of 60° C., and the pressure was slowly raised to 30 bar. After the system had stabilized, a second permeate 14 was collected. When 15 l of the second permeate 14 had been collected, the pressure was released, 5 l of a second retentate 13 were discharged and evaporated to dryness to obtain a decolorized palm wax (light yellow, with a Pantone color number of 600U).

The first nanofiltration membrane provided a wax components rejection of 70% at a flux of 50 l/(m²h). The second nanofiltration membrane provided a wax components rejection of 95% at a flux of 40 l/(m²h).

### Example 4

### Decolorization and Concentration of Rice Bran Wax

5 l of a solution of 200 g/l of crude rice bran wax (dark brown with a Pantone color number of 476U, available from Huzhou Shengtao Biotech LLC.) in isopropanol was prepared at 70° C. and provided in feed tank 1. Pump 3 was adjusted to provide a flow rate of 150 l/h, the system was kept at a temperature of 60° C. and the pressure was slowly raised to 30 bar. After the system stabilized, a first permeate 6 was collected at a flow rate of about 1 l/h, and feed tank 1 was continuously replenished with a 60° C. solution of 80 g/l rice bran wax in isopropanol at a flow rate of 1 l/h.

20 l of the first permeate 6 were collected and added to the liquid feed tank 8. Pump 10 was adjusted to provide a flow rate of 150 l/h, the system was kept at a temperature of 60° C., and the pressure was slowly raised to 30 bar. After the system had stabilized, a second permeate 14 was collected. When 15 l of the second permeate 14 had been collected, the pressure was released, 5 l of a second retentate 13 were discharged and evaporated to dryness to obtain a decolorized rice bran wax (bright yellow, with a Pantone color number of 110U).

The first nanofiltration membrane provided a wax components rejection of 60% at a flux of 10 l/(m²h). The second nanofiltration membrane provided a wax components rejection of 90% at a flux of 8 l/(m²h).

### LIST OF REFERENCE SIGNS

1 Feed tank
2 Stream to the first nanofiltration membrane
3 Pump
4 First nanofiltration membrane
5 First retentate
6 First permeate
7 Vegetable wax raw material liquid
8 Feed tank
9 Stream to the second nanofiltration membrane
10 Pump
11 Second nanofiltration membrane
12 Second retentate
13 Steam of second retentate
14 Second permeate
15 Back pressure valve
16 Back pressure valve

1-15. (canceled)

16. A method for decolorizing a vegetable wax, the method comprising:
a) providing a vegetable wax raw material liquid comprising an organic solvent and a vegetable wax dissolved therein;
b) providing a selectively permeable first nanofiltration membrane having a first surface and a second surface; and
c) bringing said raw material liquid into contact with the first surface of said first nanofiltration membrane to transfer a portion of said raw material liquid across the first nanofiltration membrane, from the first surface to the second surface, thereby forming a first permeate and a first retentate,
wherein the pressure at the first surface of the first nanofiltration membrane is higher than the pressure at the second surface of the first nanofiltration membrane, said vegetable wax comprises a pigment and a wax component, and the rejection of said first nanofiltration membrane for said pigment is higher than that for said wax component.

17. The method of claim 16, wherein said first nanofiltration membrane comprises a material selected from the group consisting of: polyethylene, polypropylene, polytetrafluoroethylene (PTFE), polyvinylidene fluoride (PVDF), polysulfone, polyethersulfone, polyacrylonitrile, polyamide, polyimide, polyamideimide, polyetherimide, cellulose acetate, polyaniline, polypyrrole, polyetheretherketone (PEEK), polybenzimidazole and mixtures thereof.

18. The method of claim 16, wherein said first nanofiltration membrane consists of a composite material comprising a carrier and a selectively permeable layer.

19. The method of claim 18, wherein the selectively permeable layer contains a material selected from the group consisting of: a modified polysiloxane-based elastomer, a polydimethylsiloxane (PDMS)-based elastomer, an ethylene-propylene-diene (EPDM)-based elastomer, a polynorbornene-based elastomer, a polycyclooctene-based elastomer, a polyurethane-based elastomer, a butadiene and butadiene-acrylonitrile rubber-based elastomer, a natural rubber, a butyl rubber-based elastomer, a neoprene-based elastomer, an epichlorohydrin elastomer, a polyacrylate elastomer, polyethylene, polypropylene, polytetrafluoroethylene (PTFE), a polyvinylidene fluoride (PVDF)-based elastomer, a polyether block amide (PEBAX), a crosslinked polyether, polyamide, polyaniline, polypyrrole, and mixtures thereof.

20. The method of claim 19, wherein the selectively permeable layer comprises a polysiloxane-based elastomer.

21. The method of claim 16, wherein said first nanofiltration membrane comprises a silicone-coated polyacrylonitrile-based nanofiltration membrane.

22. The method of claim 16, wherein said first nanofiltration membrane has a molecular weight cut-off of from about 300 g/mol to about 1,500 g/mol.

23. The method of claim 16, wherein said vegetable wax is selected from the group consisting of palm wax, candelilla wax, rice bran wax, sugarcane wax, laurel wax, castor bean wax, jojoba wax, urushi wax, ouricury wax, sunflower wax, and douglas fir bark wax.

24. The method of claim 16, wherein said organic solvent is selected from the group consisting of: aromatic hydrocarbons, aliphatic hydrocarbons, ketones, esters, ethers, nitriles, alcohols, furans, lactones and mixtures thereof.

25. The method of claim 24, wherein said organic solvent is selected from the group consisting of: toluene, xylene, benzene, styrene, methyl acetate, ethyl acetate, isopropyl acetate, butyl acetate, methyl ether ketone (MEK), methyl isobutyl ketone (MIBK), acetone, isopropanol, propanol, butanol, hexane, heptane, cyclohexane, dimethoxyethane, methyl tert-butyl ether (MTBE), diethyl ether, adiponitrile, dioxane, tetrahydrofuran, methyl-tetrahydrofuran, N-methylpyrrolidone, N-ethylpyrrolidone, acetonitrile and mixtures thereof.

26. The method of claim 16, wherein said first retentate is recycled to the first surface of said first nanofiltration membrane, optionally combined with said vegetable wax raw material liquid.

27. The method of claim 16, wherein said vegetable wax raw material liquid is continuously replenished with a replenishing liquid that is said organic solvent or a solution of said vegetable wax in the organic solvent.

28. The method of claim 27, wherein the concentration of the vegetable wax in the replenishing liquid does not exceed the concentration of the vegetable wax in said first permeate.

29. The method of claim 27, wherein said second permeate is used as replenishing liquid or for preparing the replenishing liquid.

30. The method of claim 16, wherein the operating conditions for said first nanofiltration membrane comprise at least one of:
a) a temperature of 10 to 100° C.;
b) a transmembrane pressure difference of 10 to 60 bar;
c) a vegetable wax concentration of 10 to 500 g/l.

31. The method of claim 16, further comprising bringing said first permeate into contact with a second nanofiltration membrane to transfer a portion of said first permeate across the second nanofiltration membrane, from a first surface of the second nanofiltration membrane to a second surface of the second nanofiltration membrane, thereby forming a second permeate and a second retentate, wherein the pressure at the first surface of the second nanofiltration membrane is greater than the pressure at the second surface of the second nanofiltration membrane and the rejection of said second nanofiltration membrane for said wax component is at least 80%.

32. The method of claim 31, wherein said second nanofiltration membrane has a higher rejection for said wax component than said first nanofiltration membrane.

33. The method of claim 31, wherein said second nanofiltration membrane has a molecular weight cut-off of from about 150 g/mol to about 300 g/mol.

34. The method of claim 31, wherein said second retentate is recycled to the first surface of said second nanofiltration membrane, optionally combined with said first permeate.

35. The method of claim 31, wherein said second nanofiltration membrane comprises a polyimide-based nanofiltration membrane.

36. The method of claim 31, wherein the operating conditions for said second nanofiltration membrane comprise:
a) a temperature of 10 to 100° C.;
b) a transmembrane pressure difference of 10 to 60 bar.
